(19) United States
(12) Patent Application Publication
(10) Pub. No.: US 2013/0277346 A1
(43) Pub. Date: Oct. 24, 2013

(54) CATALYST SUBSTRATES AND METHOD OF FORMING USING CAPACATIVE DISCHARGE WELDING

(71) Applicant: ACAT GLOBAL, Charlevoix, MI (US)

(72) Inventors: Randy Waffle, Bellaire, MI (US); Michael Lunkas, Otisville, MI (US); Paul Daniel, JR., Traverse City, MI (US)

(21) Appl. No.: 13/833,070

(22) Filed: Mar. 15, 2013

Related U.S. Application Data
(60) Provisional application No. 61/613,977, filed on Mar. 21, 2012.

(51) Int. Cl. B23K 9/00; B23K 9/32

(52) U.S. Cl. CPC B23K 9/0035; B23K 9/32
USPC 219/137 R; 219/158

(57) ABSTRACT

A fixture for welding a substrate using capacitive discharge welding includes a support plate having a receiving portion. A back plate that is generally planar is positioned adjacent a rear wall of the support plate and perpendicular thereto, wherein the support plate and back plate are made from a non-conductive material. Another fixture for welding a substrate includes a pair of support plates having a cut-out forming a receiving portion. A back plate that is generally planar is positioned adjacent a rear wall of one of the support plates, wherein the support plate and back plate are made from a non-conductive material. A method of welding a substrate using capacitive discharge welding is also provided.

### CROSS-REFERENCE TO RELATED APPLICATIONS

This application claims priority to U.S. Provisional Patent Application 61/613,977 filed on Mar. 21, 2012, which is hereby incorporated by reference in its entirety.

### TECHNICAL FIELD

The present disclosure relates generally to capacitive discharge welding of a catalytic converter substrate and in particular to a catalyst substrate having a predetermined shape and a method of forming the same by discharge welding.

A substrate for use as a catalyst in a catalytic converter can be prepared using various techniques. The substrate itself includes layers of a material that are joined together to form an integral structure having a predetermined shape. Various strategies are known for joining the layers, such as by controlled atmosphere furnace brazing and capacitive discharge welding. One example of the use of capacitive discharge welding is taught by commonly owned U.S. Pat. No. 5,051,294, to Lunkas et al., entitled “Catalytic Converter Substrate and Assembly”. While this process works, its use is limited to certain sizes and shapes of substrates, also referred to as bricks. For larger sized bricks or bricks having a non-linear shape, capacitive discharge welding does not work due to formation problems such as “burn through” and weld strength. Metal substrates which encounter a burn-thru condition are unusable and accordingly discarded as scrap. In addition, the use of capacitive discharge welding was limited for a substrate having a low aspect ratio such as cubes and wide ovals, since the welds are physically weaker and have significantly lower concentration levels due to the shape.

For example, a substrate having a rectangular shape and a length greater than 12 inches may have welds between adjoining metal foil layers that are physically weaker and are created at significantly lower concentration levels. This increases the amount of time necessary to weld the substrate. Another disadvantage of presently available capacitive discharge techniques is in maintaining dimensional control of such a substrate through the known capacitive discharge welding process. Thus, to utilize capacitive discharge welding with these substrate profiles, the energy discharge into was reduced from 30 to 50 percent to prevent contact layer burn-thru. Other limitations were due to both poor weld formation at the point contact sites along with a significant number (between 30 to 40 percent) of point contact sites with no weld formation.

Thus, there is a need in the art for a method of forming a catalyst substrate using capacitive discharge welding that creates a stronger weld and occurs at a higher power concentration for adjoining metal foil layers. Further, there is a need for a fixture to use during capacitive discharge welding that provides for enhanced substrate sizes and profile shapes. In addition, there is a need for a fixture that allows for the full utilization of the energy discharge without a burn-thru condition.

### SUMMARY

Accordingly, a method and apparatus for forming a substrate for a catalytic converter using capacitive discharge welding is provided. A fixture for welding a rectangular substrate using capacitive discharge welding includes a generally rectangular support plate having a receiving portion. A back plate that is generally planar is positioned adjacent a rear wall of the support plate and perpendicular thereto, wherein the support plate and back plate are made from a non-conductive material. A fixture for welding a round substrate includes a pair of generally rectangular support plates having a semi-spherical cut-out forming a receiving portion. A back plate that is generally planar is positioned adjacent a rear wall of one of the support plates, wherein the support plate and back plate are made from a non-conductive material. A method of welding a substrate using capacitive discharge welding includes the steps of selecting an upper electrode and a lower electrode for the capacitive discharge welder, wherein the width of the electrode matches a width of a metal layer and a length of the electrode matches a length of the metal layer. The methodology also includes the steps of aligning a plurality of metal layers on a fixture having a receiving portion for the metal layers and positioning the fixture between the upper electrode and lower electrode. The methodology further includes the steps of sequentially welding the metal layers at weld projections to form an integral substrate.

An advantage of the present disclosure is that a fixture for a rectangular substrate having an overall length over 12 inches is provided that enables preparation of the substrate using capacitive discharge welding. Another advantage of the present disclosure is that a fixture for a substrate having a spherical shape is provided so that a spherical substrate can be prepared using capacitive discharge welding. Still another advantage of the present disclosure is that the fixture improves alignment of the metal layers to establish a stronger weld. Yet still another advantage of the present disclosure is that use of the fixture enables a higher discharge of capacitive energy to weld the metal layers. A further advantage of the present disclosure is that the fixture facilitates welding of an increased number of weld projections due to increase contact area between the stack and electrodes. Still yet a further advantage of the present disclosure is that the available contact surface area of the electrodes is more fully utilized to balance the distribution and flow of the energy discharge through the stacks. Yet a further advantage of the present disclosure is that material costs are reduced due to reduced part scrappage. A further advantage of the present disclosure is that the fixture and electrode design combined with center to outer edge weld sequencing better distributes the upper electrode preload force, increases the total upper and lower electrode contact surface area and captures the metal foil layers in a manner that allows a full energy release without contact layer burn-thru. Yet another advantage of the present disclosure is that the welding apparatus may be used to fabricate stacked thin metal foil assembles, and such assemblies may be used for heat exchangers, spark arrestors, media filtering, particulate traps, and chemical anti-poisoning catalysts. Yet still another advantage of the present disclosure is that substrates for fuel cell reformers may be supplied as the elimination of brazing eliminates nickel and thereby reduces reformer efficiency.

### BRIEF DESCRIPTION OF THE DRAWINGS

FIG. 1 is a perspective view of a fixture used in forming a long brick for use in a capacitive discharge welding machine.

FIG. 2 is a perspective view of a fixture for forming a spherical substrate, for use in a capacitive discharge welding machine.

FIG. 3 is a flowchart illustrating a method of welding a substrate using a capacitive discharge welding machine.

FIG. 4 is diagrammatic view of a weld sequence for use in welding a long brick of FIG. 1.

FIG. 5 is a perspective view of a formed long brick of FIG. 1.

FIG. 6 is a perspective view of a formed spherical substrate of FIG. 2.

FIG. 7 is a block diagram of a welding apparatus.

### DETAILED DESCRIPTION

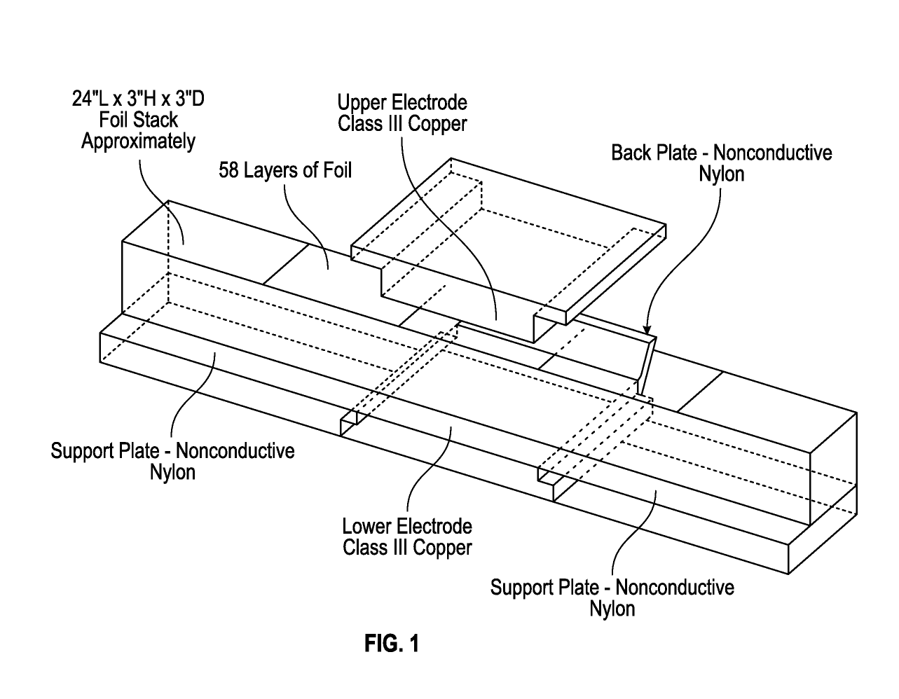

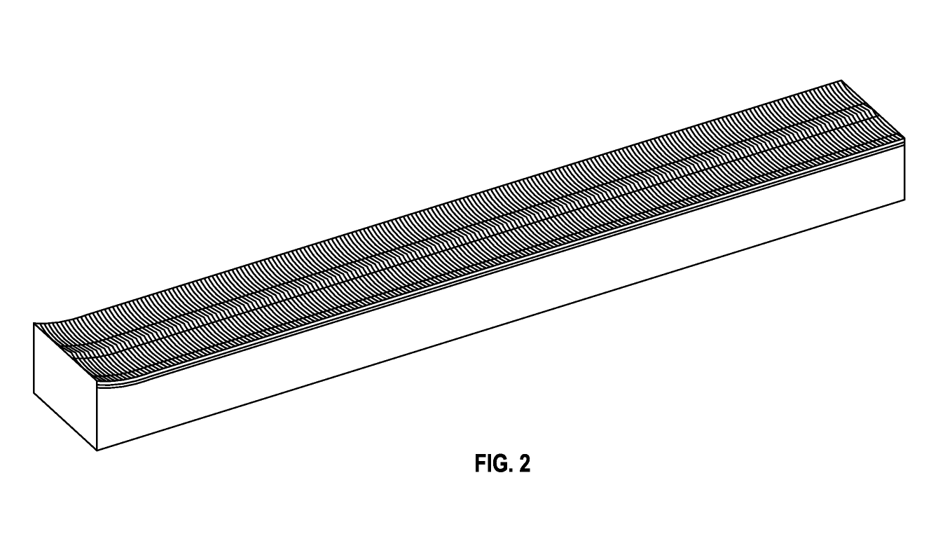

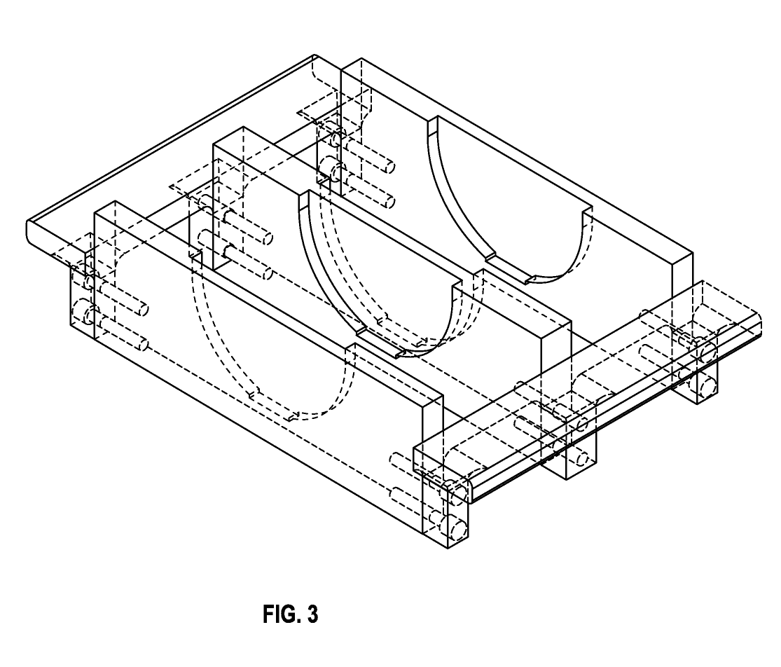

Referring to FIGS. 1-4 and 7 a welding apparatus 200 for capacitive discharge welding is illustrated. Capacitive discharge welding is a joining process that relies on the discharge of capacitive energy applied at weld projections associated with a work piece 12 in order to form a joint. The welding apparatus 200 includes a base 202. The base 202 provides a support structure for the components associated with the welding apparatus 200. The welding apparatus 200 also includes a controller 204 having a processor 206 for controlling operation of the welding apparatus 200 in a manner to be described. The welding apparatus 200 also includes a first energy source 208 which is a transformer having a plurality of capacitors that deliver a predetermined pulse of energy to the weld projection, and a mechanism for charging the capacitors to a predetermined high voltage. The welding apparatus 200 also includes a second energy source 210 that is an electrode that delivers a discharge current at a low voltage. In this example, the welding apparatus 200 includes an upper electrode plate 16 and a lower electrode plate 18. The electrode plates (16, 18) are formed of a conductive material, which in this example is a class III copper, although other materials are contemplated. The size and shape of each electrode plate is selectively determined to balance the ratio between the upper and lower contact surface areas and the total surface area of the electrode that is in contact with the work piece 12 to be welded. In addition, the size and shape of each electrode (16, 18) improves distribution of the upper electrode preload force, increases the total upper and lower electrode contact surface area and captures the metal foil layers in a manner that allows a full energy release without contact layer burn-thru. An actuator operatively in communication with the processor 106 may control movement of the electrode plates (16, 18) with respect to the controller 104 so that the electrode plate can apply a weld pressure in a manner to be described.

The work piece 12 of this example is a catalytic converter substrate. The substrate includes a plurality of metal layers that are welded together at weld projections to form an integral member for use as a catalyst in a catalytic converter. Each individual metal layer has an embossed corrugation, and when the layers are placed on top of each other, the projections form a predetermined pattern, which in this example is a chevron or herringbone or the like. The corrugations form the weld projections. The metal layers are positioned within a fixture, to be described, and welded together. It should be appreciated that welding of various types of objects are contemplated using the fixture and methodology to be described.

The fixture 10 is positioned on a table portion of the base, and arranged between the opposed electrode plates (16, 18). The table may be movable in a manner to be described. In an example of a fixture for a substrate having a long rectangular shape, the fixture 10 includes a support plate 20 that is generally planar in shape. The support plate 20 has a length and width corresponding to that of the object to be welded. The support plate 20 includes a top wall 20a, opposed bottom wall 20b, and a pair of opposed sidewalls 20c extending therebetween the top wall 20a and bottom wall 20b, and a front wall 20d and an opposed rear wall 20e. The support plate 20 is formed from a non-conductive material, such as nylon or the like.

The rectangular fixture 10 also includes a generally planar back plate 22 located adjacent the fixture rear wall 20e and extending perpendicular thereto. The back plate 22 of this example is centrally located with respect to the rear wall 20e and extends a predetermined distance above the top wall 20a of the support plate 20. The back plate 22 is likewise formed of a non-conductive material. The metal layers to be welded are positioned on a receiving portion of the fixture top wall 20a as a stack and oriented so as to abut the back plate 22. The fixture 10 may accommodate various sizes of substrates, such as those having an overall length between 12-36 inches, although other sizes are contemplated. An example of a larger sized substrate is 23 inches by 24 inches. Advantageously, the fixture 10 incorporates dimensional control features that stabilize the welded and un-welded portions of the metal layers during the welding process.

In another example, a weld fixture for a nonlinear work piece 30, such as a spherical substrate is disclosed. The weld fixture for a spherical member 30 includes a plurality of support plates 32 that are arranged parallel to each other. Each plate 32 is generally planar, and includes a semi-spherical cut-out portion 34 that is the receiving portion for the metal layers. The semi-spherical cut-out portion 34 corresponds in shape and size to the substrate to be welded. Each plate 32 is positioned so that the cut-out portion 34 faces in an upward direction. The support plates 32 are made from a non-conductive material, such as nylon. In this example, there are two sets of 2 support plates, and a back plate 36 separates each set of support plates 32. Each set of support plates 32 corresponds to one work piece. Advantageously, each half of the spherical work piece can be welded simultaneously using a single energy discharge. Similar to the previously described fixture for a rectangular substrate 10, the back plate 36 assists in the alignment of the layers of material to be welded. The weld fixture for the nonlinear work piece 30 also includes a pair of opposed frame members 38 that span each of the sets of support plates, and an end wall 32a of each support plate 32 is secured to the frame member 38. For example, a fastener 40 such as a screw or bolt or the like may be utilized to secure the support plate 32 to the each of the frame members 38. The back plate 36 and frame members 38 may likewise be fabricated from a predetermined non-conductive material.

The arrangement of the material layers as a stack on the support plates 32 allows for full utilization of the available weld projections. In addition, the fixture 30 enables the full rated energy (FRE) of the capacitive discharge welder to be discharged into net shaped non-linear or spherical metal foil stacks of this example. Advantageously, a range of work-piece diameters can be accommodated using the fixture 30, such as between 1.5 to 7 inches. The interaction between the positioning of the metal layers with respect to each of the upper and lower metal layer contact surfaces and the upper and lower electrodes facilitates the distribution of maximum weld energy. As previously described, when the fixture 30 is in contact with the weld electrodes both the upper and lower contact area ratio as well as the total available surface contact area is optimized. For example, almost 100 percent of the weld projections are utilized. The final diameter and width of the metal substrate desired may be used to determine the best number of half spherical stacks welded with each fixture 30 and electrode pairing. Once the metal layers are welded into a single semi-spherical work piece or substrate, each semi-spherical substrate may be welded together to form a spherical substrate. As a result of the initial weld of the semi-spherical stack, flow and distribution of released welding energy is improved.

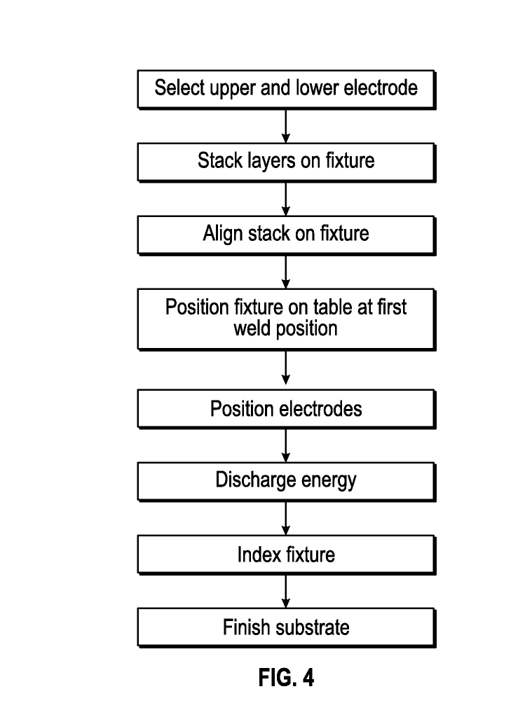

Referring to FIG. 4, a method of welding a work piece using capacitive discharge welding is provided. The methodology begins in block 100 with the step of selecting an upper and lower electrode by determining the shape and dimensions of the electrode. For example, the width of the metal layer is used to determine the width of the electrodes, such as the depth of the metal layer for a rectangular substrate. The length of the electrodes is determined based on the length of the electrode across the stack. The height of the welded part is determined based on the height of the stack.

The methodology advances to block 105 and includes the step of stacking a predetermined number of layers of a metal material on the receiving portion of the fixture. As previously described, the fixture may be for a spherical substrate of a rectangular substrate.

The methodology advances to block 110 and the stack of metal material layers are aligned on the receiving portion of the fixture. For example, the stack is located so as to abut the back plate.

The methodology advances to block 115 and the fixture is positioned on the table of the welding apparatus at a first weld position.

The methodology advances to block 120 and the upper electrode and lower electrode are positioned around the stack. For example, the upper electrode may be lowered so as to compress the metal layers between the upper electrode and lower electrode by applying a predetermined pressure to the stack. The fixture may be spring loaded to facilitate compression of the stack.

The methodology advances to block 125 and the capacitive energy is discharged by the welder into a predetermined location of the stack in the first position and for a predetermined period of time. For example, an initial energy of 18000 joules and secondary voltage of 2400 Volts is discharged at a predetermined rate continuously through the material layers. An example is 10 seconds per weld event. The predetermined location is a weld projection. As a result, a sequential series of full rated energy release welds may be created. Advantageously, a lot of power is discharged in a short period of time. The weld energy and location may be selectively determined using a formula based on volume of stack, including layer thickness, height of stack, length of stack, and weld projection pattern.

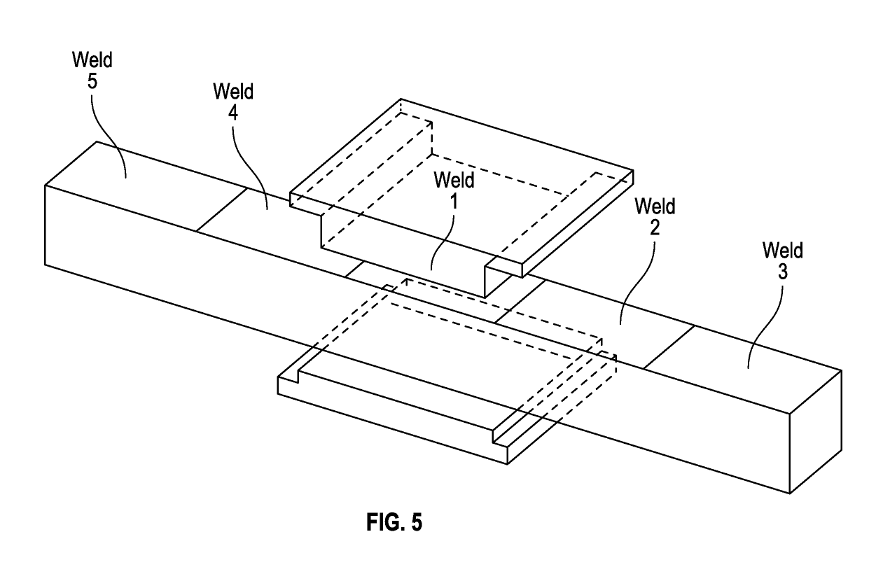

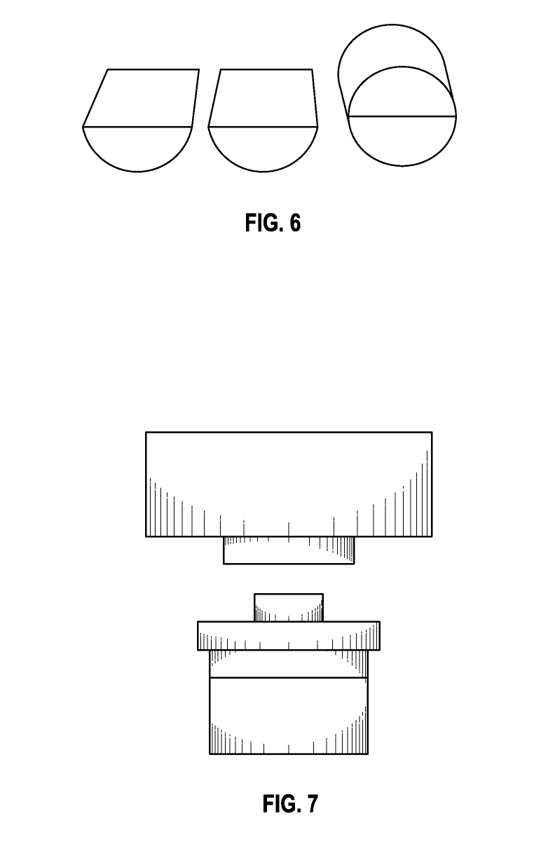

The methodology advances to block 130 and the fixture is indexed to another predetermined weld position. The weld position is selectively determined so that there is a predetermined amount of overlap between the first weld position and an adjacent weld position. If the amount of overlap is excessive, burn through may occur, and if insufficient, poor weld strength could occur. In an example of a rectangular substrate, the sequence of weld positions may be selected as shown in FIG. 5. Movement of the fixture may be accomplished by lateral movement of the table portion of the base. The specific sequencing of the welds along with the fixture and electrode designs provides for full energy release welds, resulting in excellent as-welded strength. The alignment of the stack stabilizes the welded and un-welded portions of the stack during the welding process. A stack can be welded at full strength while being held to specific dimensional tolerances of height, width and chamber. The final length and height of the specific substrate desired may also used to determine the best sequencing order and weld overlap. An example of a sequence is center of the stack, then a first side of stack and then an opposite side of the stack. The sequence may be influenced by the metal layer thickness and weld projection patterns.

The methodology advances to block 135 and the substrate is finished. For example, two substrates may be welded together, i.e. weld together each semi-spherical substrate to from a spherical substrate. Advantageously, weld time for the substrate is reduced, such as to 90 seconds for a rectangular brick 23 by 24 inches.

The present disclosure has been described in an illustrative manner. It is to be understood that the terminology which has been used is intended to be in the nature of words of description rather than of limitation. Many modifications and variations of the present example are possible in light of the above teachings. Therefore, within the scope of the appended claims, the present disclosure may be practices other than as specifically described.

What is claimed as new and desired to be protected by Letters Patent of the United States is:

1. A fixture for welding a rectangular substrate using capacitive discharge welding comprising:
a generally rectangular support plate having a receiving portion; and
a back plate that is generally planar and is adjacent a rear wall of the support plate and perpendicular thereto, wherein the support plate and back plate are made from a non-conductive material.

2. A fixture for welding a round substrate using capacitive discharge welding comprising:
a pair of generally rectangular support plates having a semi-spherical cut-out forming a receiving portion; and
a back plate that is generally planar and is adjacent a rear wall of one of the support plates, wherein the support plate and back plate are made from a non-conductive material.

3. A method of welding a substrate using capacitive discharge welding, said method including the steps of:
selecting an upper electrode and a lower electrode for a capacitive discharge welder, wherein the width of the electrode matches a width of a metal layer and a length of the electrode matches a length of the metal layer;
aligning a plurality of metal layers on a fixture having a receiving portion for the metal layers;
positioning the fixture between the upper electrode and lower electrode; and
sequentially welding the metal layers at weld projections to form an integral substrate.
